(19) United States
(12) Patent Application Publication
(10) Pub. No.: US 2016/0343409 A1
(43) Pub. Date: Nov. 24, 2016

(54) METHOD AND DEVICE FOR VIDEO PREVIEW

(71) Applicant: Lemobile Information Technology (Beijing) Co., Ltd., Beijing (CN)

(72) Inventors: Xiaobin WANG, Beijing (CN); Bo LI, Beijing (CN); Liang LI, Beijing (CN); Xizhe XIAO, Beijing (CN); Shengkai WANG, Beijing (CN); Shixing LI, Beijing (CN)

(21) Appl. No.: 15/158,525

(22) Filed: May 18, 2016

(30) Foreign Application Priority Data
May 19, 2015 (CN) 201510256983.X

(51) Int. Cl. G11B 27/10; H04N 21/472; H04N 5/783; H04N 5/92; G11B 27/36

(52) U.S. Cl. CPC G11B 27/102; H04N 5/9206; G11B 27/36; H04N 5/783; H04N 21/47217

(57) ABSTRACT

The embodiments of the disclosure provide a method and device for video preview. The method includes: with the determination of a need to enter a video preview interface, obtaining a respective preview control corresponding to at least one playback position for playing a preview video in a video preview interface; loading video data of respective one way of preview video corresponding to each of the preview controls; and playing the video data of the respective one way of preview video in each of preview controls. The embodiments of the disclosure can reflect preview video contents accurately in real time, allowing the user to rapidly and accurately find the desirable video, improving the user experience. The video preview manner may have enhanced universality, especially applicable to the preview of the videos having varied contents in real time such as live broadcast and carousel.

### CROSS-REFERENCE TO RELATED APPLICATIONS

The present disclosure is based upon and claims priority to Chinese Patent Applications No. CN201510256983.X filed May 19, 2015, the entire contents of all of which are incorporated herein by reference.

### FIELD OF TECHNOLOGY

The embodiments of the disclosure relate to the field of multimedia technologies, and in particular to a method and a device for video preview.

### BACKGROUND

With a rapid development of multimedia technologies, video applications for playing video are having increasing types and more enhanced functions. A user may install a video application on a mobile terminal and enjoy video through the video application. Further, with an improvement of basic facilities for internet, network speed is increased while the cost of internet becomes inexpensive. The number of users watching videos through the mobile terminals is being subjected to an explosive growth. The video application may play a plenty of videos for the users. For example, the user may watch live broadcast, carousel and satellite programs by the video application. However, the user more and more expects to rapidly and accurately find a desirable video from plenty of videos.

In the prior art, for the purpose of more conveniently watching videos for the user, the video application may be provide a video preview function, in which a frame of video image is captured for a recommended video and video images corresponding to the recommended videos are displayed in an interface of the video application. The user may initially sense the video content on the basis of the video image and then select a desirable video.

However, in above video preview manner, only a frame of video image is displayed. Therefore, above manner is merely applicable to video-on-demand having fixed contents. For the videos having varied contents in real time such as live broadcast and carousel, the video contents could not be accurately reflected simply by the displayed video image. Therefore, above video preview manner has poor universality, could not allow the user to rapidly and accurately find the desirable video and thus has an interior user experience.

### SUMMARY

The embodiments of the disclosure propose a method and a device for video preview, to address problems that the video preview manner in the prior art has poor universality, could not allow the user to rapidly and accurately find the desirable video and thus has an interior user experience

The embodiment of the disclosure provides a method for video preview, including:

with the determination of a need to enter a video preview interface, obtaining a respective preview control corresponding to at least one playback position for playing a preview video in a video preview interface;

loading video data of respective one way of preview video corresponding to each of the preview controls; and

playing the video data of the respective one way of preview video in each of preview controls.

The embodiment of the disclosure provides a device for video preview, including:

a control obtaining module, configured to, with the determination of a need to enter a video preview interface, obtain a respective preview control corresponding to at least one playback position for playing a preview video in a video preview interface;

a video loading module, configured to load video data of respective one way of preview video corresponding to each of the preview controls; and

a preview playing module, configured to play the video data of the respective one way of preview video in each of preview controls.

The embodiment of the disclosure provides an electronic terminal for video preview, characterized in that, the electronic terminal comprises:

at least one processor;

a memory for storing at least one instruction executable by the processor;

wherein the processor is configured to perform:
with the determination of a need to enter a video preview interface, obtaining a respective preview control corresponding to at least one playback position for playing a preview video in a video preview interface;
loading video data of respective one way of preview video corresponding to each of the preview controls; and
playing the video data of the respective one way of preview video in each of preview controls.

There are provided a method and a device for video preview in the embodiments of the disclosure. At least one playback position may be provided in the video preview interface of the video application, and each may display the preview control capable of playing the preview video. With the determination of the need to enter the video preview interface, it is possible to load video data of respective one way of preview video corresponding to each of the preview controls. Therefore, it is possible to invoke the preview control in the video preview interface which is displayed for the user and play the video data of respective one way of preview video in each of preview controls. The embodiments of the disclosure may replace the manner of displaying the video image for the user's preview in the prior art with the playback of the preview video in real time. Therefore, the preview video contents can be reflected accurately and in real time, allowing the user to rapidly and accurately find the desirable video, improving the user experience. The video preview manner may have enhanced universality, especially applicable to the preview of the videos having varied contents in real time such as live broadcast and carousel.

### BRIEF DESCRIPTION OF THE DRAWINGS

In order to more apparently describe the technical schemes in the embodiments of the disclosure or in the prior art, accompanying figures necessarily used in the description of the embodiments or the prior art will be simply explained hereinafter. Obviously, the accompanying figures described below will form the embodiments of the disclosure. An ordinary person skilled in the art may conceive further figures in accordance with these accompanying figures without contributing creative labor.

FIG. 1 is a flow chart of a method for video preview according to a first embodiment of the disclosure;

FIG. 2a is a flow chart of a method for video preview according to a second embodiment of the disclosure;

FIG. 2b is a schematic representation of an up-slide on a position out of controls in a video preview interface according to the second embodiment of the disclosure;

FIG. 2c is a schematic representation of movement of controls in FIG. 2b;

FIG. 2d is a schematic representation of the video preview interface after the controls in FIG. 2b are moved;

FIG. 2e is a schematic representation of a left-slide on controls in row 1 in the video preview interface according to the second embodiment of the disclosure;

FIG. 2f is a schematic representation of the video preview interface after the controls in FIG. 2e are moved;

FIG. 2g is a schematic representation of a left-slide on a position out of controls in a video preview interface according to the second embodiment of the disclosure;

FIG. 2h is a schematic representation of the video preview interface after the controls in FIG. 2g are moved;

FIG. 3 is a block diagram of a device for video preview according to a third embodiment of the disclosure; and

FIG. 4 is a block diagram of a device for video preview according to a fourth embodiment of the disclosure.

### DESCRIPTION OF THE EMBODIMENTS

In order that objectives, technical schemes and advantages of the embodiments of the disclosure become more apparent, the technical schemes in the embodiments of the disclosure will be thoroughly and completely described below in conjunction with the accompanying figures in the embodiments of the disclosure. It is obvious that the embodiments described herein are some of embodiments of the disclosure rather than entire embodiments. On the basis of the embodiments of the disclosure, other embodiments conceived by an ordinary person skilled in the art without creative labor would all fall into the protection scope of the disclosure.

### First Embodiment

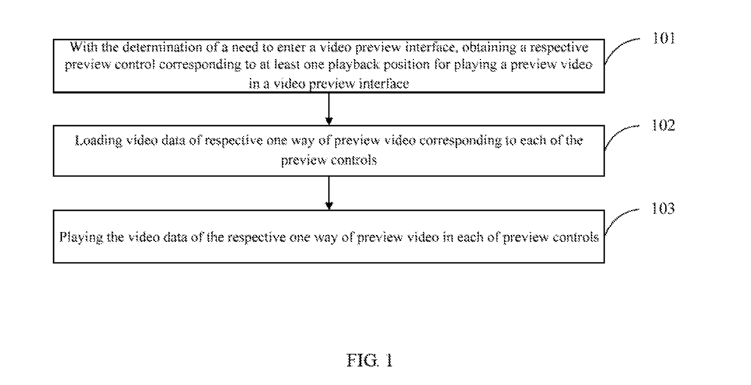

With reference to FIG. 1, it shows a flow chart of a method for video preview according to the first embodiment of the disclosure.

The method for video preview in this embodiment may include steps of:

Step 101, with the determination of a need to enter a video preview interface, obtaining a respective preview control corresponding to at least one playback position for playing a preview video in a video preview interface.

The method for video preview in this embodiment may be applicable to a video application which can be installed in a mobile terminal. A user may watch the video through the video application on the mobile terminal. Herein, the mobile terminal could be mobile phone, tablet, notebook, etc.

The video application may provide the video preview interface in which at least one playback position is arranged. Each way of preview videos may correspond to a preview control which is able to play this channel of preview video. Each of playback positions may display a preview control, which means each of playback positions may play one way of preview video. Since the number of preview videos may exceed that of playback positions, a portion of preview videos which is equal to the number of the playback positions can be viewed in the video preview interface. If there is a need to view more preview videos, further operations will be necessarily executed (detailed process thereof will be described later in the second embodiment). Therefore, in this embodiment, a respective default preview control of a playback position may be predefined for each of playback positions, wherein the respective default preview control refers to a preview control displayed on the playback position after the initial entry to the video preview interface. Therefore, with determination of a need to enter the video preview interface, the respective default preview control of at least one playback position may be initially obtained.

Step 102, loading video data of respective one way of preview video corresponding to each of the preview controls.

Since the preview video is played in the video preview interface, it is necessary to load the video data corresponding to the preview video, for subsequently normally playing the preview video. In this embodiment, for the preview controls corresponding to their respective playback positions, the video data of respective one way of preview video corresponding to each of the preview controls may be loaded.

Step 103, playing the video data of the respective one way of preview video in each of preview controls.

After the completion of loading the video data of preview video corresponding to a preview control, the corresponding video data of preview video can be played in the preview control. Therefore, each of preview controls can play the video data of respective one way of preview video. Herein, “completion of loading” refers to a case in which the loaded video data can be normally played rather than the completion of loading all the video data of preview video. For example, the playback may begin once a predefined number of frames of video data are loaded, and then the loading keeps on while playing back. The specific value of the predefined number of frames may be selected from any suitable values by those skilled in the art according to the practical experience, for example 3 frames, or 4 frames, which should be restricted by the embodiment of the disclosure.

At least one playback position may be provided in the video preview interface of the video application according to this embodiment of the disclosure. Each of playback positions may display the preview control capable of playing the preview video, thereby replacing the manner of displaying the video image for the user's preview in the prior art with the playback of the preview video in real time. Therefore, the preview video contents can be reflected accurately and in real time, allowing the user to rapidly and accurately find the desirable video, improving the user experience. The video preview manner may have enhanced universality, especially applicable to the preview of the videos having varied contents in real time such as live broadcast and carousel.

### Second Embodiment

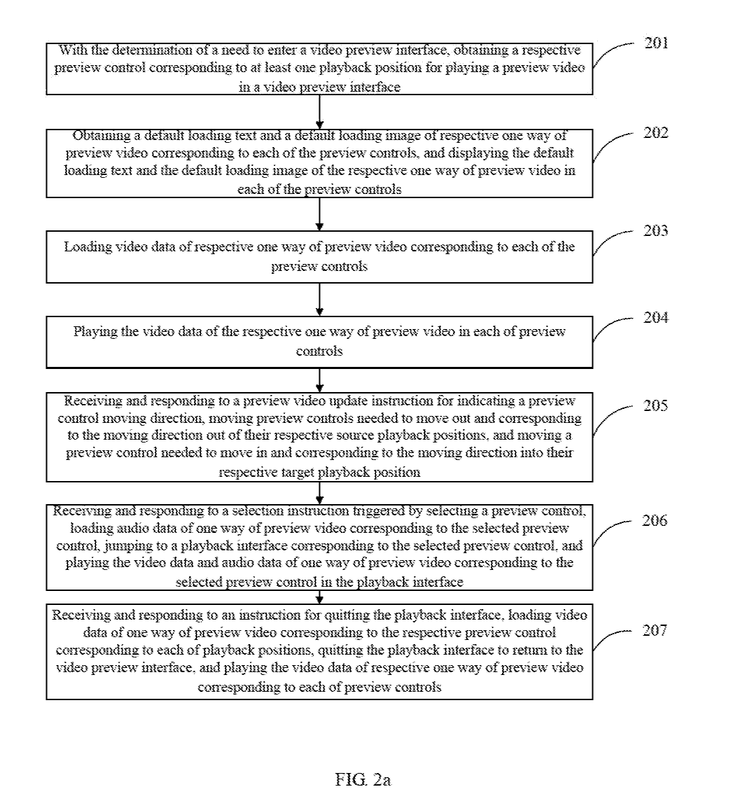

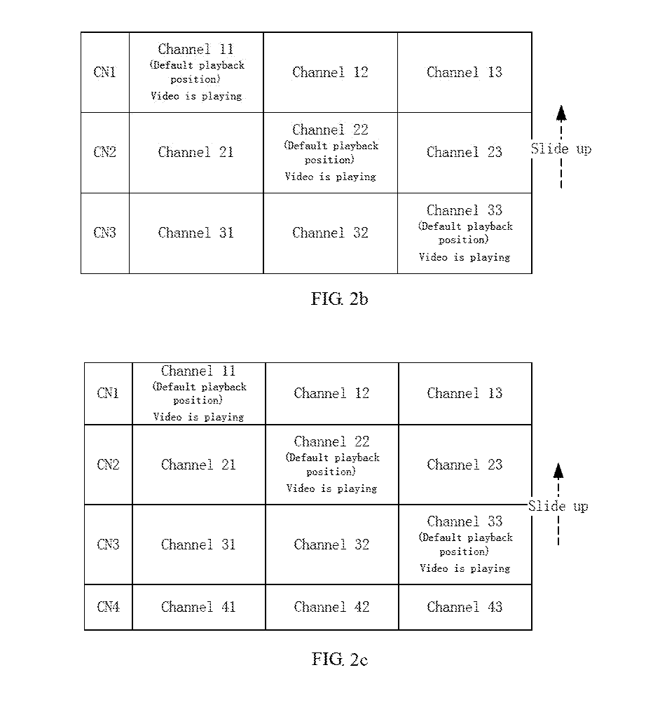

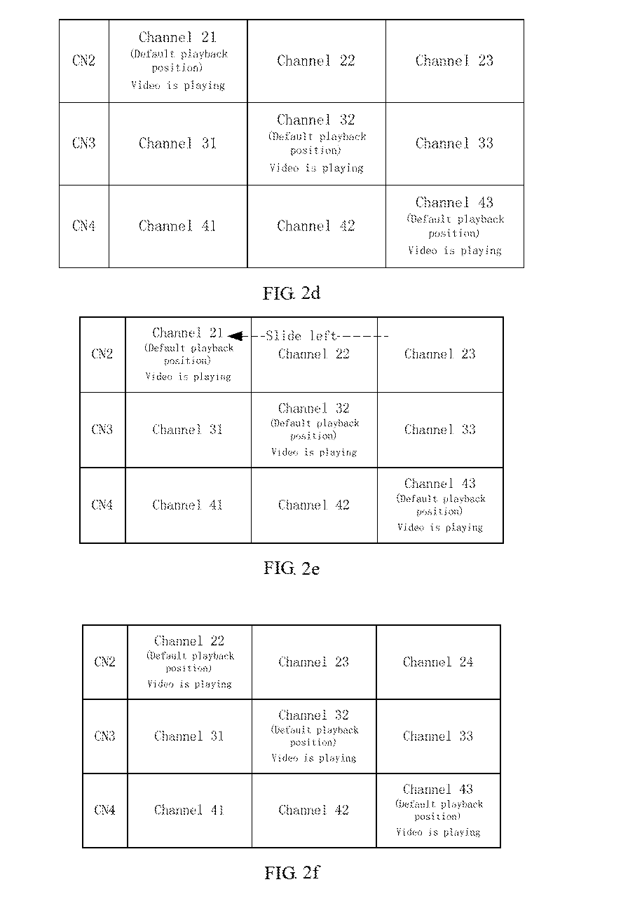

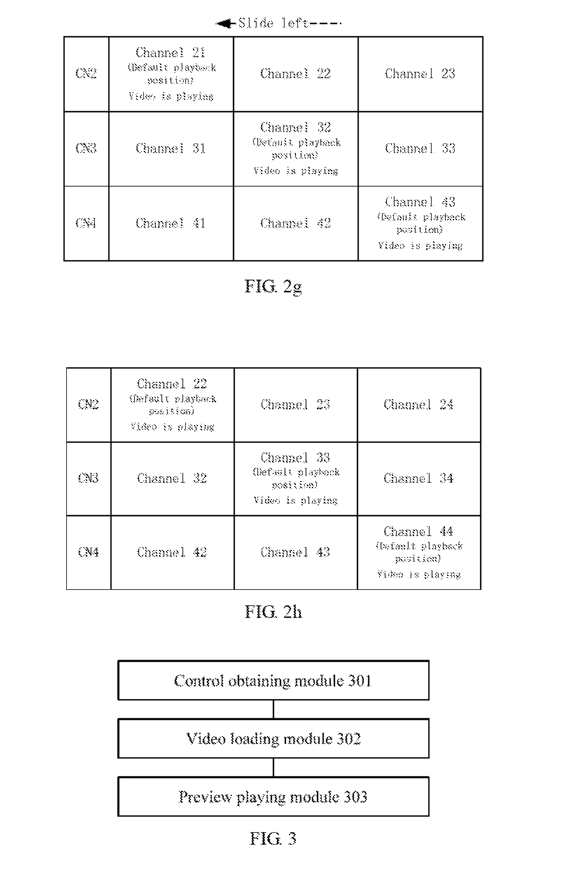

With reference to FIG. 2a, it shows a flow chart of a method for video preview according to a second embodiment of the disclosure.

The method for video preview in this embodiment may include steps of:

Step 201, with the determination of a need to enter a video preview interface, obtaining a respective preview control corresponding to at least one playback position for playing a preview video in a video preview interface.

This embodiment may be applicable to electronic terminals which could be mobile phone, PAD, PC/tablet, for example. The method for video preview according to this embodiment may particularly applicable to a video application installed in the electronic terminal. A display interface of the electronic terminal may include at least one category video display region, the category video display region may include a first display sub-region and at least one second display sub-region, the first display sub-region may be used to display a video category identifier, the second display sub-region may be used to display a video preview window, and the video preview window may be used to display video information corresponding to a video in the video category. When a position where a second display sub-region is positioned is the playback position, the video preview window displayed in the second display sub-region may also used to load the preview control, so as to obtain from the video preview window and then load to play the corresponding video data. The video as stated in this embodiment could be live-broadcast video or video-on-demand video.

In this embodiment, it may be specified that the method for video preview is used only for some special types of videos. For example, the method for video preview is used only for the videos having varied contents in real time such as live broadcast, carousel and satellite program. When the video is the live-broadcasting video, the video category identifier could be a channel category identifier, the video preview window could be a channel display window, and the channel display window may be used to display channel information corresponding to a channel in the channel category.

The video application could be above special type of video application (for example, a live-broadcasting application), or could also be comprehensive type of video application (for example, a Letv video application). If the video application is the special type of video application, a homepage of the video application may be set to be the video preview interface. Therefore, when an instruction for actuating the video application is received, a need to enter the video preview interface may be determined. If the video application is the comprehensive type of video application, then a channel page corresponding to above special type of channel (for example, a live-broadcasting channel and carousel channel) of the video application may be set to be the video preview interface. Therefore when an instruction for jumping to the special type of channel of the video application is received, a need to enter the video preview interface may be determined.

The video preview interface may include at least one playback position. The specific number of the playback positions is not restricted by the embodiment, for example 9 playback positions arranged by 3 rows×3 columns (i.e., a Sudoku arrangement), or 12 playback positions arranged by 3 rows×4 columns. The playback positions in Sudoku arrangement will be described in this embodiment as an example. For the playback positions in other arrangements, related operations could be made with reference to the Sudoku form by those skilled in the art.

The video preview interface may correspond to multiple ways of preview video. A preview control (item control) for playing the way of preview video may be generated for each way of preview video. Relevant information of the preview video (for example, video stream address and audio stream address of the preview video) may be described backstage in a form of playback instance. One way of preview video may correspond to a playback instance. A plurality of playback instances may be arranged backstage in an array form. For example, in the case that the video preview interface corresponds to 36 ways of preview video, the corresponding 36 playback instances may be arranged by 6 rows×6 columns. The video preview interface is displayed in the Sudoku form, wherein Sudoku refers to the number of preview controls which can be displayed on each screen of the mobile terminal. The displayed preview controls may be varied by sliding the screen in the video preview interface, but the number thereof is kept constant. Therefore, it may be predefined that each of playback positions corresponds to its respective default preview control. For example, the preview controls corresponding to the preview videos indicated by 9 playback instances in the Sudoku form, which starts from row 1, column 1 in the playback instance array, may be used as the default preview controls corresponding to the playback positions in the Sudoku forms, respectively. Of course, preview controls corresponding to preview videos indicated by playback instances in another position may also be used as the default preview controls corresponding to playback positions. This should be restricted by the embodiment.

Step 202, obtaining a default loading text and a default loading image of respective one way of preview video corresponding to each of the preview controls, and displaying the default loading text and the default loading image of the respective one way of preview video in each of the preview controls.

In this embodiment, the preview controls may employ a multi-control embedded layout manner. Each of preview controls may include a text control in a first floating layer, an image control in a second floating layer and a playback control in a third floating layer. In other words, the text control, the image control and the playback control are embedded in the preview control, wherein the third floating layer is in a lower layer below the second floating layer and the second floating layer is in a lower layer below the first floating layer. It should be explained that, in this embodiment, a distance between the lower layer and the mobile terminal screen is larger than a distance between an upper layer and the mobile terminal screen.

For each way of preview video, the default loading text and the default loading image corresponding to this way of preview video may be predefined, and the default loading text and the default loading image corresponding to this way of preview video may be displayed before the preview video is played, allowing the user to preliminarily obtain relevant information of the preview video before the video is played. Therefore, after the default preview control corresponding to at least one playback position is obtained, the default loading text and the default loading image of one way of preview video corresponding to each of preview controls may be obtained to display the video preview interface, and the default loading text and the default loading image of the respective one way of preview video in each of the preview controls may be displayed.

Preferably, in this embodiment, the step of displaying the default loading text and the default loading image of the respective one way of preview video in each of the preview controls may include: invoking the text control included in the preview control on the first floating layer of each of preview controls, and displaying the default loading text of one way of preview video corresponding to the preview control in the text control; and invoking the image control included in the preview control on the second floating layer of each of preview controls, and displaying the default loading image of one way of preview video corresponding to the preview control in the image control.

Any suitable settings may be made to aforesaid default loading text and default loading image by those skilled in the art according to the practical experience. For example, at least one sentence of texts in the preview video reflecting key contents of the video may be used as the default loading text, at least one frame of image in the preview video reflecting key contents of the video may be used as the default loading image. This should not be restricted by the embodiment.

Step 203, loading video data of respective one way of preview video corresponding to each of the preview controls.

Before the preview video is played, it is necessary to first load the video data of preview video, i.e., to load video data of respective one way of preview video corresponding to each of the preview controls. This process may include: obtaining video stream address of respective one way of preview video corresponding to each of the preview controls, and obtaining the video data from the video stream address of the corresponding one way of preview video.

It should be explained that, in this embodiment, Step 203 is not limited to following Step 202. Step 203 and Step 202 may be executed simultaneously. Also, Step 203 may be executed before Step 202. This should be restricted by the embodiment.

Step 204, playing the video data of the respective one way of preview video in each of preview controls.

After the completion of loading the video data of preview video corresponding to a preview control, the corresponding video data of preview video can be played in the preview control. It should be explained that, since data speed of loading different video stream address may be different, the preview controls may not play the corresponding video data of preview video simultaneously. This may be dependent particularly upon the video data loading.

Preferably, Step 204 may include: hiding the first floating layer and the second floating layer of each of preview control; invoking the playback control included in the preview control on the third floating layer of each of the preview controls, and playing the video data of one way of preview video corresponding to the preview control in the playback control. Since the playback control is embedded in the preview control, when the preview video is played, the text control and the image control in the upper layer can be hidden to display the playback control in a bottom layer. Therefore, it is possible to avoid the controls in the upper layer from covering the playback of video and improve the effect of playback without interfering with the manipulation of the control.

In above process, only the video data of preview video is played in the video preview interface, while audio data of the preview video is not played. Preferably, in this embodiment, it is also possible to play the audio data of the preview video. However, in order to avoid deteriorating the user's experience due to noises generated from the multiple ways of preview video, in this embodiment the audio data of only one way of preview video is played with blocking audio data of remaining preview videos. A playback position, in which audio data of preview video played by the preview control, may be specified in advance.

Preferably, therefore, the method for video preview in this embodiment may further include a following Step A: loading audio data of one way of preview video corresponding to the preview control in a pre-specified playback position. Step A may include: obtaining audio stream address of one way of preview video corresponding to the preview control in the pre-specified playback position, and obtaining the audio data of one way of preview video corresponding to the preview control in the pre-specified playback position from the audio stream address. Step A may be executed simultaneously with Step 203 or may be executed before or after Step 203. Correspondingly to Step A, Step 204 in this embodiment may be changed to be: playing the video data and audio data of the respective one way of preview video in the preview control in the pre-specified playback position, and playing the video data of the respective one way of preview video in other preview controls except for the preview control in the pre-specified playback position.

Step 205, receiving and responding to a preview video update instruction for indicating a preview control moving direction, moving preview controls needed to move out and corresponding to the moving direction out of their respective source playback positions, and moving a preview control needed to move in and corresponding to the moving direction into their respective target playback position.

Only preview videos corresponding to a certain number of preview controls are displayed in the video preview interface. As described in Step 201, the video preview interface includes 9 playback positions in the Sudoku arrangement. Therefore, only 9 ways of preview video corresponding to 9 preview controls can be displayed, although the video preview interface corresponds to 36 ways of preview video. If, therefore, the user would like to watch the remaining preview videos not shown, relevant operations may be performed through the video preview interface to update the displayed preview videos.

Preferably, the user may make a slide touch on the video preview interface to trigger a preview video update instruction. The preview video update instruction may contain slide direction information. The slide direction information may indicate a moving direction of the preview control. The moving direction may correspond to a preview control needed to move out and a preview control needed to move in. In this embodiment, the preview controls needed to move out may be set to be all preview controls which are currently displayed in the video preview interface. Or the preview controls needed to move out may also be set to be a portion of preview controls which are currently displayed in the video preview interface. The number of the preview control needed to move in may be equal to that of the preview control needed to move out.

Upon the receipt of the preview video update instruction, the video application may respond to the preview video update instruction, to update the currently displayed preview video in the video preview interface. The preview control needed to move out corresponding to the moving direction may be moved out from its respective source playback position. The preview control needed to move in corresponding to the moving direction may be moved into its respective target playback position. If the preview controls needed to move out are all the preview controls which are currently displayed in the video preview interface, then preview controls needed to move out (i.e., all the preview controls which are currently displayed) corresponding to the moving direction may be directly moved out from their respective source playback positions, and the preview controls needed to move in corresponding to the moving direction may be directly moved into the target playback position; if the preview controls needed to move out are a portion of preview controls which are currently displayed in the video preview interface, then besides that the preview control needed to move out (i.e., a portion of preview controls which are currently displayed) corresponding to the moving direction may be moved out from their respective source playback positions, the remaining preview controls which are not moved out (i.e., the remaining preview controls which are not moved out and which are currently displayed) may be necessarily moved from their respective source playback positions to their respective target playback positions in the moving direction, and the preview control needed to move in corresponding to the moving direction may be moved into their respective target playback positions.

It should be explained that before the preview controls needed to move in corresponding to the moving direction are moved into their respective target playback position, the method may further include: loading video data of respective one way of preview video corresponding to each of preview controls needed to move in, in order to ensure that when the preview controls needed to move in and indicated by the moving direction are moved into their respective target playback positions, video data of respective one way of preview video can be played in each of moved-in preview controls, and after the preview controls needed to move out are moved out, the moved-out preview controls can stop playing their respective preview videos.

Hereinafter, the case wherein the preview controls needed to move out are a portion of preview controls which are currently displayed in the video preview interface will be described as an example. For other cases, related operations could be made with reference to the description in this embodiment by those skilled in the art.

Hereinafter, the Sudoku in which the playback positions are row 1 by column 1, row 2 by column 2 and row 3 by column 3 will be described as an example. Herein, a control corresponding to a playback position is a preview control, and a control corresponding to a non-playback position is a view control.

If the slide direction information is an up-slide, then the moving direction of the preview control indicated by the slide direction information may be up-movement. The controls needed to move out corresponding to the moving direction would be three controls in row 1 of the Sudoku. The controls needed to move in corresponding to the moving direction would be three controls corresponding to three playback instances in a next row of row 3, columns 1-3 of the Sudoku in backstage playback instance queue. In response to the preview video update instruction, three controls in row 1 of the Sudoku are moved out, three controls in row 2 are moved into their respective positions in row 1, three controls in row 3 are moved into their respective positions in row 2, and controls needed to move in are moved into their respective positions in row 3 of the Sudoku. Hereinafter, the case of an up-slide will be described by taking FIG. 2b-FIG. 2d as an example. FIG. 2b is a schematic representation of an up-slide on a position out of controls in a video preview interface. The video preview interface may include three category navigations which are category navigation (CN) 1, category navigation (CN) 2 and category navigation (CN) 3, respectively, wherein controls currently displayed by the category navigation (CN) 1 are the preview control of channel 11, the view control of channel 12 and the view control of channel 13 in row 1; controls currently displayed by the category navigation (CN) 2 are the view control of channel 21, the preview control of channel 22 and the view control of channel 23 in row 2; and the controls currently displayed by the category navigation (CN) 3 are the view control of channel 31, the view control of channel 32 and the preview control of channel 33 in row 3. The up-slide (i.e., an “up-slide” arrow in FIG. 2b) is made on a position on the right side of the controls in the video preview interface as shown in FIG. 2b. FIG. 2c shows a schematic representation of movement of controls in FIG. 2b, wherein the preview control of channel 11, the view control of channel 12 and the view control of channel 13 which correspond to the original row 1 of the category navigation (CN) 1 are moved gradually out of row 1; the view control of channel 21, the preview control of channel 22 and the view control of channel 23 which correspond to the original row 2 of the category navigation (CN) 2 are gradually moved towards row 1; the view control of channel 31, the view control of channel 32 and the preview control of channel 33 which correspond to the original row 3 of the category navigation (CN) 3 are gradually moved towards row 2; and the view control of channel 41, the view control of channel 42 and the view control of channel 43 which correspond to a newly moved-in category navigation (CN) 4 are gradually moved towards row 3. FIG. 2d shows a schematic representation of the video preview interface after the controls in FIG. 2b are moved. The video preview interface may include three category navigations which are the category navigation (CN) 2, the category navigation (CN) 3 and the category navigation (CN) 4, respectively, wherein controls currently displayed by the category navigation (CN) 2 are the preview control of channel 21, the view control of channel 22 and the view control of channel 23 in row 1; controls currently displayed by the category navigation (CN) 3 are the view control of channel 31, the preview control of channel 32 and the view control of channel 33 in row 2; and controls currently displayed by the category navigation (CN) 4 are the view control of channel 41, the view control of channel 42 and the preview control of channel 43 in row 3.

If the slide direction information is a down-slide, then the moving direction of the preview control indicated by the slide direction information may be down-movement. The controls needed to move out corresponding to the moving direction would be three controls in row 3 of the Sudoku. The controls needed to move in corresponding to the moving direction would be three controls corresponding to three playback instances in a previous row of row 1, columns 1-3 of the Sudoku in backstage playback instance queue. In response to the preview video update instruction; three controls in row 3 of the Sudoku are moved out; three controls in row 2 are moved into their respective positions in row 3, three controls in row 1 are moved into their respective positions in row 2; and controls needed to move in are moved into their respective positions in row 1 of the Sudoku.

If the slide direction information is a left-slide on the controls in a single row in the video preview interface, then the moving direction of the preview control indicated by the slide direction information may be left-movement. The control needed to move out corresponding to moving direction would be a control in column 1 of this single row in the Sudoku. The controls needed to move in corresponding to the moving direction would be a control corresponding to a playback instance in a next column of column 3 of this single row of the Sudoku in backstage playback instance queue. In response to the preview video update instruction, the control in column 1 of this single row of the Sudoku is moved out; the control in column 2 of this single row is moved into its respective position in column 1 of this single row; the control in column 3 of this single row is moved into its respective position in column 2 of this single row; and a control needed to move in is moved into its respective position in column 3 of this single row. Hereinafter, the case of a left-slide on a control in a single row in the video preview interface will be described by taking FIG. 2e-FIG. 2f as an example. FIG. 2e shows a schematic representation of a left-slide on controls in row 1 in the video preview interface. The video preview interface may include three category navigations which are category navigation (CN) 2, category navigation (CN) 3 and category navigation (CN) 4, respectively, wherein controls currently displayed by the category navigation (CN) 2 are the preview control of channel 21, the view control of channel 22 and the view control of channel 23 in row 1; controls currently displayed by the category navigation (CN) 3 are the view control of channel 31, the preview control of channel 32 and the view control of channel 33 in row 2; and controls currently displayed by the category navigation (CN) 4 are the view control of channel 41, the view control of channel 42 and the preview control of channel 43 in row 3. The left-slide (i.e., a “left-slide” arrow in FIG. 2e) is made on the controls in row 1 in the video preview interface as shown in FIG. 2e. FIG. 2f shows a schematic representation of the video preview interface after the controls in FIG. 2e are moved. The video preview interface may include three category navigations which are the category navigation (CN) 2, the category navigation (CN) 3 and the category navigation (CN) 4, respectively, wherein controls currently displayed by the category navigation (CN) 2 are the preview control of channel 22, the view control of channel 23 and the view control of channel 24 in row 1; controls currently displayed by the category navigation (CN) 3 are the view control of channel 31, the preview control of channel 32 and the view control of channel 33 in row 2; and controls currently displayed by the category navigation (CN) 4 are the view control of channel 41, the view control of channel 42 and the preview control of the channel 43 in row 3.

If the slide direction information is to control the video preview interface as a whole to leftwards slide, then the moving direction of the preview control indicated by the slide direction information may be left-movement. The controls needed to move out corresponding to the moving direction would be three controls in column 1 of the Sudoku. The controls needed to move in corresponding to the moving direction would be three controls corresponding to three playback instances in a next column of column 3, rows 1-3 of the Sudoku in backstage playback instance queue. In response to the preview video update instruction, three controls in column 1 of the Sudoku are moved out; three controls in column 2 are moved into their respective positions in column 1; three controls in column 3 are moved into their respective positions in column 2; and controls needed to move in are moved into their respective positions in column 3 of the Sudoku. Hereinafter, the case of a left-slide on a position out of controls in the video preview interface will be described by taking FIG. 2g-FIG. 2h as an example. FIG. 2g shows a schematic representation of a left-slide on a position out of controls in the video preview interface. The video preview interface may include three category navigations which are category navigation (CN) 2, category navigation (CN) 3 and category navigation (CN) 4, respectively, wherein controls currently displayed by the category navigation (CN) 2 are the preview control of channel 21, the view control of channel 22 and the view control of channel 23 in row 1; controls currently displayed by the category navigation (CN) 3 are the view control of channel 31, the preview control of channel 32 and the view control of channel 33 in row 2; and controls currently displayed by the category navigation (CN) 4 are the view control of channel 41, the view control of channel 42 and the preview control of channel 43 in row 3. The left-slide (i.e., a “left-slide” arrow in FIG. 2g) is made on a position above the controls in the video preview interface as shown in FIG. 2g. FIG. 2h shows a schematic representation of the video preview interface after the controls in FIG. 2g are moved. The video preview interface may include three category navigations which are the category navigation (CN) 2, the category navigation (CN) 3 and the category navigation (CN) 4, respectively, wherein controls currently displayed by the category navigation (CN) 2 are the preview control of channel 22, the view control of channel 23 and the view control of channel 24 in row 1; controls currently displayed by the category navigation (CN) 3 are the view control of channel 32, the preview control of channel 33 and the view control of channel 34 in row 2; and controls currently displayed by the category navigation (CN) 4 are the view control of channel 42, the view control of channel 43 and the preview control of channel 44 in row 3.

If the slide direction information is a right-slide on the controls in a single row in the video preview interface, then the moving direction of the preview control indicated by the slide direction information may be right-movement. The control needed to move out corresponding to moving direction would be a control in column 3 of this single row in the Sudoku. The controls needed to move in corresponding to the moving direction would be a control corresponding to a playback instance in a previous column of column 1 of this single row of the Sudoku in backstage playback instance queue. In response to the preview video update instruction, the control in column 3 of this single row of the Sudoku is moved out; the control in column 2 of this single row is moved into its respective position in column 3 of this single row; the control in column 1 of this single row is moved into its respective position in column 2 of this single row; and a control needed to move in is moved into its respective position in column 1 of this single row.

If the slide direction information is to control the video preview interface as a whole to rightwards slide, then the moving direction of the preview control indicated by the slide direction information may be right-movement. The controls needed to move out corresponding to the moving direction would be three controls in column 3 of the Sudoku. The controls needed to move in corresponding to the moving direction would be three controls corresponding to three playback instances in a previous column of column 1, rows 1-3 of the Sudoku in backstage playback instance queue. In response to the preview video update instruction, three controls in column 3 of the Sudoku are moved out; three controls in column 2 are moved into their respective positions in column 3, three controls in column 1 are moved into their respective positions in column 2; and controls needed to move in are moved into their respective positions in column 1 of the Sudoku.

Step 206, receiving and responding to a selection instruction triggered by selecting a preview control, loading audio data of one way of preview video corresponding to the selected preview control, jumping to a playback interface corresponding to the selected preview control, and playing the video data and audio data of one way of preview video corresponding to the selected preview control in the playback interface.

In this embodiment, each of preview controls may further correspond to a playback interface for normally playing the preview video corresponding to the preview control. A preview control may be selected to enter the playback interface corresponding to the preview control, and the video corresponding to the preview control may be normally played in the playback interface.

Preferably, the selection instruction may be trigger by selecting a preview control. The selection instruction may be used to indicate the selected preview control. Upon the receipt of the selection instruction, the video application may respond to the selection instruction. Since the video data of preview video corresponding to the selected preview control is being loaded, and video data and audio data are necessarily played simultaneously when the video is normally played, the audio data of one way of preview video corresponding to the selected preview control may be loaded. The process of loading may include: obtaining audio stream address of one way of preview video corresponding to the selected preview control, and obtaining the audio data of one way of preview video corresponding to the selected preview control from the audio stream address. Therefore, after the jump to the playback interface corresponding to the selected preview control, the video data and audio data of one way of preview video corresponding to the selected preview control may be played in the playback interface. The preview control in the video preview interface may stop playing the preview video after the jump.

Step 207, receiving and responding to an instruction for quitting the playback interface, loading video data of one way of preview video corresponding to the respective preview control corresponding to each of playback positions, quitting the playback interface to return to the video preview interface, and playing the video data of respective one way of preview video corresponding to each of preview controls.

In this embodiment, it is possible to trigger the instruction for quitting the playback interface. For example, the playback interface is provided with a quit key control. The instruction for quitting the playback interface may be triggered when the quit key control is clicked. The video application may receive and respond to the instruction for quitting the playback interface, reload video data of one way of preview video corresponding to the respective preview control corresponding to each of playback positions, quit the playback interface after it is loaded, return to the video preview interface, and play the video data of respective one way of preview video corresponding to each of preview control.

It should be explained that the respective preview control corresponding to each of playback positions at Step 207 could be the respective default preview control corresponding to each of playback positions at Step 201 as described above, or the respective preview control corresponding to each of playback positions in the video preview interface before the jump to the playback interface. That is to say, the video preview interface before the jump to the playback interface would be an interface after a slide operation, in which the respective preview control corresponding to each of playback positions is no longer the respective default preview control.

This embodiment proposes a new video preview mode, in which a video preview for at least one way of video stream is displayed in current display interface/window, allowing the user to rapidly and accurately find the desirable video while satisfying the requirement for the user to watch multiple ways of videos.

The method embodiments as described above, for the purpose of brief description, are described as a series of combined actions. However, it should be appreciated by those skilled in the art that the embodiments of the disclosure should not be restricted by the sequence of the actions as set forth, since some of actions could be performed in different sequence or simultaneously according to the embodiments of the disclosure. Moreover, it should also be appreciated by those skilled in the art that, the embodiments as described in the specification are preferred embodiments and actions concerned are not necessarily required in the embodiments of the disclosure.

### Third Embodiment

With reference to FIG. 3, it shows a block diagram of a device for video preview according to a third embodiment of the disclosure.

The device for video preview according to this embodiment may include following modules:

a control obtaining module 301, configured to, with the determination of a need to enter a video preview interface, obtain a respective preview control corresponding to at least one playback position for playing a preview video in a video preview interface;

a video loading module 302, configured to load video data of respective one way of preview video corresponding to each of the preview controls; and

a preview playing module 303, configured to play the video data of the respective one way of preview video in each of preview controls.

At least one playback position is provided in the video preview interface of the video application according to this embodiment of the disclosure. Each of playback positions may display the preview control capable of playing the preview video, thereby changing the manner of displaying the video image for the user's preview in the prior art to the playback of the preview video in real time. Therefore, the preview video contents can be reflected accurately and in real time, allowing the user to rapidly and accurately find the desirable video, improving the user experience. The video preview manner may have enhanced universality, especially applicable to the preview of the videos having varied contents in real time such as live broadcast and carousel.

### Fourth Embodiment

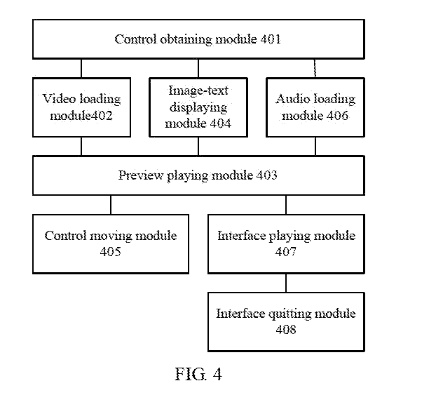

With reference to FIG. 4, it shows a block diagram of a device for video preview according to a fourth embodiment of the disclosure.

The device for video preview according to this embodiment may include following modules:

a control obtaining module 401, configured to, with the determination of a need to enter a video preview interface, obtain a respective preview control corresponding to at least one playback position for playing a preview video in a video preview interface;

a video loading module 402, configured to load video data of respective one way of preview video corresponding to each of the preview controls; and

a preview playing module 403, configured to play the video data of the respective one way of preview video in each of preview controls.

Preferably, the device for video preview may further include: an image-text displaying module 404, configured to, after the control obtaining module obtains the respective preview control corresponding to at least one playback position for playing the preview video in a video preview interface, obtain a default loading text and a default loading image of respective one way of preview video corresponding to each of the preview controls, and display the default loading text and the default loading image of the respective one way of preview video in each of the preview controls.

Preferably, each of preview controls may further include a text control in a first floating layer and an image control in a second floating layer, wherein the second floating layer is in a lower layer below the first floating layer. The image-text displaying module may include: a text displaying sub-module, configured to invoke the text control included in the preview control on the first floating layer of each of preview control, and display the default loading text of one way of preview video corresponding to the preview control in the text control; and an image displaying sub-module, configured to invoke the image control included in the preview control on the second floating layer of each of preview controls, and display the default loading image of one way of preview video corresponding to the preview control in the image control.

Preferably, each of preview controls may further include a playback control in a third floating layer, wherein the third floating layer is in a lower layer below the second floating layer. The preview playing module may include: a floating layer hiding sub-module, configured to hide the first floating layer and the second floating layer of each of preview control; and a control playing sub-module, configured to invoke the playback control included in the preview control on the third floating layer of each of the preview controls, and play the video data of one way of preview video corresponding to the preview control in the playback control.

Preferably, the device for video preview may further include: a control moving module 405, configured to receive and respond to a preview video update instruction for indicating a preview control moving direction, move preview controls needed to move out and corresponding to the moving direction out of their respective source playback positions, and move a preview control needed to move in and corresponding to the moving direction into their respective target playback position.

Preferably, the device for video preview may further include: an audio loading module 406, configured to, after the control obtaining module obtains a respective preview control corresponding to at least one playback position for playing a preview video in a video preview interface, load audio data of one way of preview video corresponding to the preview control in a pre-specified playback position; and the preview playing module, also configured to play the video data and audio data of the respective one way of preview video in the preview control in the pre-specified playback position, and play the video data of the respective one way of preview video in other preview controls except for the preview control in the pre-specified playback position.

Preferably, the device for video preview may further include: an interface playing module 407, configured to receive and respond to a selection instruction triggered by selecting a preview control, load audio data of one way of preview video corresponding to the selected preview control, jump to a playback interface corresponding to the selected preview control, and play the video data and audio data of one way of preview video corresponding to the selected preview control in the playback interface.

Preferably, the device for video preview may further include: an interface quitting module 408, configured to receive and respond to an instruction for quitting the playback interface, load video data of one way of preview video corresponding to the respective preview control corresponding to each of playback positions, quit the playback interface to return to the video preview interface, and play the video data of respective one way of preview video corresponding to each of preview controls.

This embodiment proposes a new video preview mode, in which a video preview for at least one way of video stream is displayed in current display interface/window, allowing the user to rapidly and accurately find the desirable video while satisfying the requirement for the user to watch multiple ways of videos.

Since the device embodiments are substantially similar to the method embodiments as described, the description thereof is relatively simple. For the device embodiments, reference can be made to related parts of the method embodiments.

The above embodiments are described merely for a schematic purpose, wherein the units explained as individual members may or may not be physically separated, the members shown as units may or may not be physical units and they can be placed at a position or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the purpose of illustrating not limiting the technical schemes of the invention. Although the present invention has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

What is claimed is:

1. A method for video preview, characterized in that, the method comprises steps of:
with the determination of a need to enter a video preview interface, obtaining a respective preview control corresponding to at least one playback position for playing a preview video in a video preview interface;
loading video data of respective one way of preview video corresponding to each of the preview controls; and
playing the video data of the respective one way of preview video in each of preview controls.

2. The method according to claim 1, characterized in that, after the step of obtaining a respective preview control corresponding to at least one playback position for playing a preview video in a video preview interface, the method further comprises:
obtaining a default loading text and a default loading image of respective one way of preview video corresponding to each of the preview controls; and
displaying the default loading text and the default loading image of the respective one way of preview video in each of the preview controls.

3. The method according to claim 2, characterized in that, each of the preview controls comprises a text control in a first floating layer, an image control in a second floating layer and a playback control in a third floating layer, wherein the second floating layer is in a lower layer below the first floating layer, and the third floating layer is in a lower layer below the second floating layer,
the step of displaying the default loading text and the default loading image of the respective one way of preview video in each of the preview controls, comprises:
invoking the text control included in the preview control on the first floating layer of each of preview controls, and displaying the default loading text of one way of preview video corresponding to the preview control in the text control; and
invoking the image control included in the preview control on the second floating layer of each of preview controls, and displaying the default loading image of one way of preview video corresponding to the preview control in the image control,
the step of playing the video data of the respective one way of preview video in each of preview controls, comprises:
hiding the first floating layer and the second floating layer of each of preview control; and
invoking the playback control included in the preview control on the third floating layer of each of the preview controls, and playing the video data of one way of preview video corresponding to the preview control in the playback control.

4. The method according to claim 1, characterized in that, further comprises:
receiving and responding to a preview video update instruction for indicating a preview control moving direction, moving preview controls needed to move out and corresponding to the moving direction out of their respective source playback positions, and moving a preview control needed to move in and corresponding to the moving direction into their respective target playback position.

5. The method according to claim 1, characterized in that, after the step of obtaining a respective preview control corresponding to at least one playback position for playing a preview video in a video preview interface, further comprises:
loading audio data of one way of preview video corresponding to the preview control in a pre-specified playback position, and
the step of playing the video data of the respective one way of preview video in each of preview controls, comprises:
playing the video data and audio data of the respective one way of preview video in the preview control in the pre-specified playback position, and playing the video data of the respective one way of preview video in other preview controls except for the preview control in the pre-specified playback position.

6. The method according to claim 1, characterized in that, further comprises:
receiving and responding to a selection instruction triggered by selecting a preview control, loading audio data of one way of preview video corresponding to the selected preview control; and
jumping to a playback interface corresponding to the selected preview control, and playing the video data and audio data of one way of preview video corresponding to the selected preview control in the playback interface.

7. The method according to claim 6, characterized in that, after the step of jumping to a playback interface corresponding to the selected preview control and playing the video data and audio data of one way of preview video corresponding to the selected preview control in the playback interface, the method further comprises:
receiving and responding to an instruction for quitting the playback interface, loading video data of one way of preview video corresponding to the respective preview control corresponding to each of playback positions; and
quitting the playback interface to return to the video preview interface, and playing the video data of respective one way of preview video corresponding to each of preview controls.

8. An electronic terminal for video preview, characterized in that, the electronic terminal comprises:
at least one processor;
a memory for storing at least one instruction executable by the processor;
wherein the processor is configured to perform:
with the determination of a need to enter a video preview interface, obtaining a respective preview control corresponding to at least one playback position for playing a preview video in a video preview interface;
loading video data of respective one way of preview video corresponding to each of the preview controls; and
playing the video data of the respective one way of preview video in each of preview controls.

9. The electronic terminal according to claim 8, characterized in that, the processor is further configured to perform:
after obtaining the respective preview control corresponding to at least one playback position for playing the preview video in a video preview interface, obtaining a default loading text and a default loading image of respective one way of preview video corresponding to each of the preview controls, and displaying the default loading text and the default loading image of the respective one way of preview video in each of the preview controls.

10. The electronic terminal according to claim 9, characterized in that, each of the preview controls comprises a text control in a first floating layer, an image control in a second floating layer and a playback control in a third floating layer, wherein the second floating layer is in a lower layer below the first floating layer, and the third floating layer is in a lower layer below the second floating layer,
the processor is further configured to perform:
invoking the text control included in the preview control on the first floating layer of each of preview control, and displaying the default loading text of one way of preview video corresponding to the preview control in the text control; and
invoking the image control included in the preview control on the second floating layer of each of preview controls, and displaying the default loading image of one way of preview video corresponding to the preview control in the image control,
hiding the first floating layer and the second floating layer of each of preview control; and
invoking the playback control included in the preview control on the third floating layer of each of the preview controls, and playing the video data of one way of preview video corresponding to the preview control in the playback control.

11. The electronic terminal according to claim 8, characterized in that, the processor is further configured to perform:
receiving and respond to a preview video update instruction for indicating a preview control moving direction, moving preview controls needed to move out and corresponding to the moving direction out of their respective source playback positions, and moving a preview control needed to move in and corresponding to the moving direction into their respective target playback position.

12. The electronic terminal according to claim 8, characterized in that, the processor is further configured to perform:
after obtaining a respective preview control corresponding to at least one playback position for playing a preview video in a video preview interface, loading audio data of one way of preview video corresponding to the preview control in a pre-specified playback position; and
playing the video data and audio data of the respective one way of preview video in the preview control in the pre-specified playback position, and playing the video data of the respective one way of preview video in other preview controls except for the preview control in the pre-specified playback position.

13. The electronic terminal according to claim 8, characterized in that, the processor is further configured to perform:
receiving and respond to a selection instruction triggered by selecting a preview control, loading audio data of one way of preview video corresponding to the selected preview control; and
jumping to a playback interface corresponding to the selected preview control, and playing the video data and audio data of one way of preview video corresponding to the selected preview control in the playback interface.

14. The electronic terminal according to claim 13, characterized in that, the processor is further configured to perform:
receiving and responding to an instruction for quitting the playback interface, loading video data of one way of preview video corresponding to the respective preview control corresponding to each of playback positions, quitting the playback interface to return to the video preview interface, and playing the video data of respective one way of preview video corresponding to each of preview controls.
